(19) United States
(12) Patent Application Publication
(10) Pub. No.: US 2006/0140210 A1
(43) Pub. Date: Jun. 29, 2006

(54) Apparatus and method for manipulating automotive data packets

(75) Inventors: Brian Yates, San Diego, CA (US); Tudor Thomas, San Diego, CA (US)

Correspondence Address: DALINA LAW GROUP, P.C., 7910 IVANHOE AVE. #325, LA JOLLA, CA, 92037, US

(73) Assignee: Automotive Data Research Inc.

(21) Appl. No.: 11/025,637

(22) Filed: Dec. 29, 2004

(51) Int. Cl. H04L 12/26

(52) U.S. Cl. 370/466

(57) ABSTRACT

Embodiments of the invention enable the transmission and receipt of information packets to and from at least one automotive data bus that enables connectivity between automotive devices on at least one automotive data bus and external devices not originally coupled with an automotive data bus or between an automotive device residing on one automotive data bus and another automotive device residing on a different automotive bus. Devices that may be coupled with an automotive data bus that were not originally coupled with the bus include but are not limited to cell phones, garage door openers, radar detectors, digital music players, alarms, stereos, GPS receivers, PCs, PDAs, digital cameras, video cameras or any other electronic device. These external devices may be controlled by the switches on a steering wheel or radio buttons for example when coupled with embodiments of the invention. Existing devices on an automotive data bus may comprise device(s) such as for example a CD-player, MID (Multi-Information Display Buttons), menu screen, multi-function steering wheel buttons, parking distance control, radio, digital music system, digital sound processor, instrument control electronics, light control module, telephone, navigation system, integrated LCD screen, On-Board computer, On-Board computer text bar, lights, wipers, seats, seat memory and any other device originally installed in an automobile. These devices may be controlled by external devices coupled with an embodiment of the invention that is in turn coupled to the automotive data bus. For example an incoming cell phone number may be displayed on an automobile stereo display when an incoming call rings a cell phone coupled with an embodiment of the invention to the automotive data bus. Embodiments of the invention allow for the interception and delay of messages intended for a given device when an external device requests use of an automotive device. For example when the incoming number is displayed on the stereo system text display, such as a change in volume any message intended for the stereo system text display may be intercepted and delayed until the cell phone call is answered.

### BACKGROUND OF THE INVENTION

1. Field of the Invention

Embodiments of the invention described herein pertain to the field of automotive data bus interfaces. More particularly, but not by way of limitation, these embodiments enable the transmission and receipt of information packets to and from at least one automotive data bus that enables connectivity between automotive devices coupled with at least one automotive data bus and external devices not originally coupled with an automotive data bus or between an automotive device residing on one automotive data bus and another automotive device residing on a different automotive bus.

2. Description of the Related Art

An automotive data bus is a data bus that allows for the transmission and receipt of packets between a plurality of devices coupled with the automotive data bus. Automotive data buses comprise a communications protocol and a physical layer upon which data packets are transmitted. Existing automotive data buses include CAN bus, SAE J1850 bus, MOSTbus, byteflight, OBDII, FlexRay, D2B, SMARTwireX, IDB-1394, IEBus, Intellibus, LIN bus among others.

Automotive data buses are used for example to send commands in an automobile from switches on a steering wheel to the stereo volume controls. Current automotive buses are closed systems that the original equipment manufacturers do not publish communications protocols for. Automobile manufacturers have only been interested in making their own devices work in an integrated manner.

To date, there is no interface available for general purpose devices to integrate into an existing automotive data bus which allows the external devices to control automotive devices or visa versa. Since there are many electronic devices that would be well suited to augment an automobile's capabilities, there is a need for an interface that allows for the integration of external devices with the automotive devices supplied by the original equipment manufacturer.

### BRIEF SUMMARY OF THE INVENTION

Embodiments of the invention enable the transmission and receipt of information packets to and from at least one automotive data bus that enables connectivity between automotive devices on at least one automotive data bus and external devices not originally coupled with an automotive data bus or between an automotive device residing on one automotive data bus and another automotive device residing on a different automotive bus. Devices that may be coupled with an automotive data bus that were not originally coupled with the bus include but are not limited to cell phones, garage door openers, radar detectors, digital music players, alarms, stereos, GPS receivers, PCs, PDAs, digital cameras, video cameras or any other electronic device. These external devices may be controlled by the switches on a steering wheel or radio buttons for example when coupled with embodiments of the invention. Existing devices on an automotive data bus hereinafter referred to as automotive devices may comprise device(s) such as for example a CD-player, MID (Multi-Information Display Buttons), menu screen, multi-function steering wheel buttons, parking distance control, radio, digital music system, digital sound processor, instrument control electronics, light control module, telephone, navigation system, integrated LCD screen, On-Board computer, On-Board computer text bar, lights, wipers, seats, seat memory and any other device originally installed in an automobile. These devices may be controlled by external devices coupled with an embodiment of the invention that is in turn coupled to the automotive data bus. For example an incoming cell phone number may be displayed on an automobile stereo display when an incoming call rings a cell phone coupled with an embodiment of the invention to the automotive data bus. Embodiments of the invention allow for the interception and delay of messages intended for a given device when an external device requests use of an automotive device. For example when the incoming number is displayed on the stereo system text display, any message intended for the stereo system text display such as a change in volume may be intercepted and delayed until the cell phone call is answered.

Embodiments of the invention provide for at least three modes of operation depending on the topology employed on the bus. Embodiments may 1) read packets from the bus in order to control an external device via an automotive device and write packets to the bus in order to control an automotive device via an external device, 2) intercept packets, delay the packets and then transmit packets to their intended destinations and 3) act as a bridge between an automobile's data bus and a second bus on the automobile such as a diagnostic bus. For a packet translator topology allowing for reading and writing onto the automotive data bus, for example when placing an embodiment of the invention on the bus other than between the bus and an existing device, the original message will still be received by the original intended recipient. For a packet filter topology, placement of embodiments of the invention between an existing device and the automotive data bus allow for intercepting packets and the delayed delivery of packets. Placement of embodiments of the invention between two data buses in an alternate bus translator topology allows for translation of packets on one data bus to the format and requirements of the second data bus and for sharing of information between buses.

Reading from the automotive data bus in order to control an external device allows for switches on the steering wheel or stereo control panel for example to control an external device such as a cell phone or any of the other external devices previously mentioned. Writing to the automotive data bus allows for the existing devices on the automotive data bus for example the stereo text display to be controlled by an external device such as a cell phone, iPod® or garage door opener for example. In this example, the cell phone may write the caller ID out on a serial port of the phone which is translated by an embodiment of the invention into a packet compatible with the communications protocol of the automotive data bus and direct that packet to the stereo text display. Use of existing devices for example automobile steering wheel switches to control an external device such as a cell phone in this topology means that the control commands still travel to their originally intended destination unless an packet filter topology is employed.

A filter topology is utilized in intercepting packets on the automotive data bus that allows for the packets to be delayed while for example the text message on the stereo text display is maintained until a cell phone call is answered at which time the originally intended packet is then delivered to the text display of the stereo text display.

When acting as a bridge between the automotive data bus and the on-board diagnostic bus in the automobile allows for example the oil pressure to be displayed on the main digital readout for the car or on the stereo text display even if the original manufacturer did not intend for the end user to ever have access to the on board diagnostic information. Although the on-board diagnostic bus in the automobile exists, it is rarely available to the vehicle operator. Allowing the vehicle operator to access the on board diagnostic information saves the purchase of a car computer.

All three topologies may be utilized in any combination within an automobile. For example, multiple embodiments of the invention may be employed in different locations within the automotive data bus configuration concurrently. This allows for example a filter topology that utilizes embodiments of the invention situated between the automotive device and the automotive data bus to be used in combination with a packet translation topology along with a bus translator topology since there is no limit to the number of embodiments that may be utilized in an automobile.

### BRIEF DESCRIPTION OF THE DRAWINGS

FIG. 1 shows an architectural diagram of embodiments of the invention configured in the packet translator, packet filter and bus translator topologies.

FIG. 2 shows an architectural diagram of a packet translation embodiment of the invention coupling at least one external device to an automotive data bus.

FIG. 3 shows an architectural diagram of a packet filter embodiment of the invention placed in between an existing device and an automotive data bus.

FIG. 4 shows an architectural diagram of an alternate bus packet translation embodiment of the invention coupling a second automotive bus such as the On Board Diagnostic II bus to an automotive data bus.

FIG. 5 shows a first schematic diagram of a portion of an embodiment of the invention comprising an automotive data bus interface connector, powered microphone interface, audio attenuator and cell phone interface connector.

FIG. 6 shows a second schematic diagram of a portion of an embodiment of the invention comprising microprocessor, relay switch, voltage regulator and programming interface connector.

FIG. 7 shows a circuit board diagram of an embodiment of the invention as diagrammed in FIGS. 5 and 6.

FIG. 8 shows a flow diagram of an embodiment of the software running on the microprocessor of FIG. 5.

FIG. 9 shows an embodiment of the invention configured to operate as a packet translator, packet filter and as a bus translator.

FIG. 10 shows the left side of FIG. 9.

FIG. 11 shows the right side of FIG. 9.

### DETAILED DESCRIPTION OF THE INVENTION

In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Any mathematical references made herein are approximations that can in some instances be varied to any degree that enables the invention to accomplish the function for which it is designed. In other instances, specific features, quantities, or measurements well-known to those of ordinary skill in the art have not been described in detail so as not to obscure the invention, for example pull-up resistors and filtering capacitors may be employed in areas of the circuit diagrams to reduce noise as one skilled in the art will readily understand. Readers should note that although examples of the invention are set forth herein, the claims, and the full scope of any equivalents, are what define the metes and bounds of the invention.

Embodiments of the invention enable the transmission and receipt of information packets to and from at least one automotive data bus that enables connectivity between automotive devices on at least one automotive data bus and external devices not originally coupled with an automotive data bus or between an automotive device residing on one automotive data bus and another automotive device residing on a different automotive bus. Devices that may be coupled with an automotive data bus that were not originally coupled with the bus include but are not limited to cell phones, garage door openers, radar detectors, digital music players, alarms, stereos, GPS receivers, PCs, PDAs, digital cameras, video cameras or any other electronic device. These external devices may be controlled by the switches on a steering wheel or radio buttons for example when coupled with embodiments of the invention. Existing devices on an automotive data bus may comprise device(s) such as for example a CD-player, MID (Multi-Information Display Buttons), menu screen, multi-function steering wheel buttons, parking distance control, radio, digital music system, digital sound processor, instrument control electronics, light control module, telephone, navigation system, integrated LCD screen, On-Board computer, On-Board computer text bar, lights, wipers, seats, seat memory and any other device originally installed in an automobile. These devices may be controlled by external devices coupled with an embodiment of the invention that is in turn coupled to the automotive data bus. For example an incoming cell phone number may be displayed on an automobile stereo display when an incoming call rings a cell phone coupled with an embodiment of the invention to the automotive data bus. Embodiments of the invention allow for the interception and delay of messages intended for a given device when an external device requests use of an automotive device. For example when the incoming number is displayed on the stereo system text display, such as a change in volume any message intended for the stereo system text display may be intercepted and delayed until the cell phone call is answered.

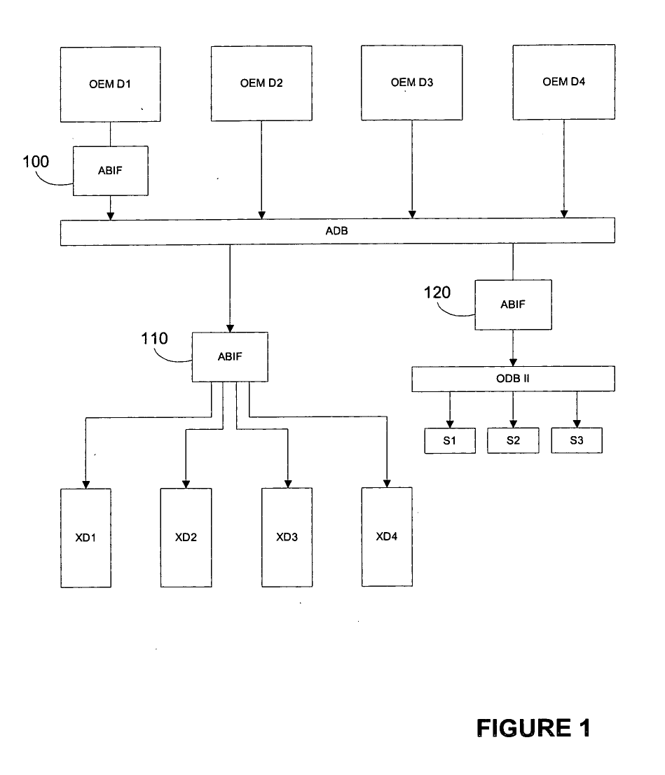

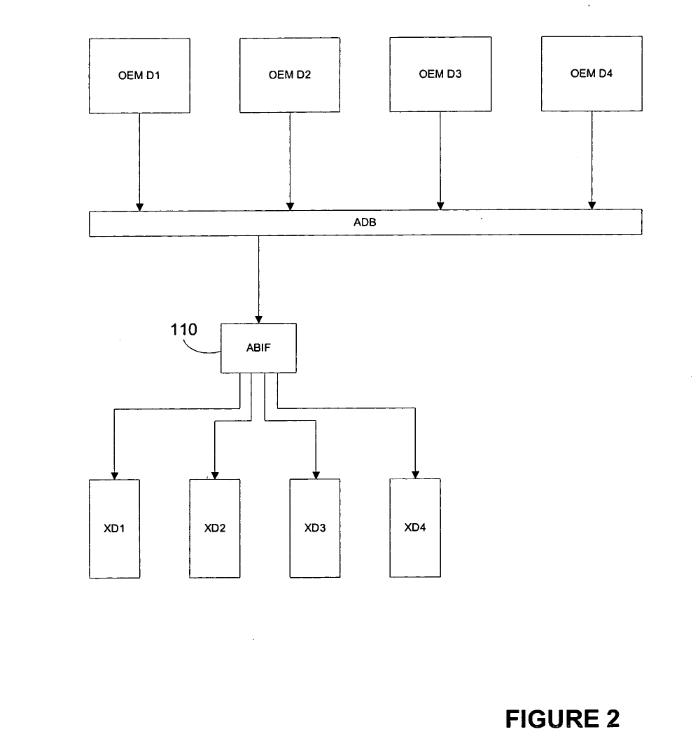

FIG. 1 shows an architectural diagram of embodiments of the invention configured in packet translation, packet filtering and alternate bus packet translation topologies. Embodiments of the invention provide for at least three modes of operation depending on the topology employed on the bus. All three topologies may used together as shown in FIG. 1 or separately as shown in FIGS. 2-4. ABIF 110 configured in the packet translator topology may read packets from Automotive Data Bus ADB in order to control an external device such as external device XD1, XD2, XD3 and/or XD4 as sent via an originally existing automotive device installed by the Original Equipment Manufacturer such as OEM D1, OEM D2, OEM D3 and/or OEM D4. ABIF 110 may also write packets to bus ADB in order to control an originally existing device such as OEM D2 for example via an external device such as XD3. ABIF 100 configured in the packet filter topology may intercept packets, delay the packets and then transmit packets to their intended destinations. ABIF 120 configured in the bus translator topology acts as a bridge between an automobile's data bus and a second bus on the automobile such as a diagnostic bus.

For example, with the configuration shown in FIG. 1, oil sensor S2 may generate a packet indicating an oil temperature over a threshold which is received by ABIF 120 and transmitted onto automotive data bus ADB. When ABIF 100 receives the translated oil pressure packet, it may display the information on stereo text display OEM D1 while ABIF 110 may translate the message for transmittal to cell phone XD4 and/or PDA XD3 in order to call a parent of the driver or schedule a maintenance event in Microsoft Outlook when the user synchronizes information at home.

Alternatively, if steering wheel switch cluster OEM D2 is activated, it may be used for activating garage door opener XD2 that was not originally installed in the automobile but which is coupled to a relay in ABIF 110. In another scenario an after market rearward pointing video camera XD1 may be activated by ABIF 110 when a distance sensor OEM D3 indicates that something is very close to the automobile in order to provide video proof of an accident for example. Integration of external devices and originally installed internal devices through embodiments of the invention enables functionalities that OEMs simply have not conceived of and do not offer.

For a packet translator topology enabled by ABIF 110 that allows for reading and writing onto the automotive data bus the original message will still be received by the original intended recipient. For example a packet derived from a steering wheel switch cluster may still be received by the cruise control system. For a packet filter topology enabled by ABIF 100, placement of embodiments of the invention between an existing device and the automotive data bus allow for intercepting of packets and the delayed delivery of packets. For the present example, this would allow steering wheel switch cluster events to be intercepted and used for some other purpose without the original packets being received by the cruise control system. Placement of embodiments of the invention between two data buses in an alternate bus packet translator topology enabled by ABIF 120 allows for translation of packets on one data bus to the format and requirements of the second data bus and for sharing of information between buses.

FIG. 2 shows an architectural diagram of a packet translation embodiment of the invention coupling at least one external device to an automotive data bus. Reading from the automotive data bus in order to control an external device allows for switches on the steering wheel or stereo control panel for example to control an external device such as a cell phone or any of the other external devices previously mentioned. Writing to the automotive data bus allows for the existing devices on the automotive data bus for example the stereo text display to be controlled by an external device such as a cell phone, iPod® or garage door opener for example. In this example, the cell phone may write the caller ID out on a serial port of the phone which is translated by an embodiment of the invention into a packet compatible with the communications protocol of the automotive data bus and direct that packet to the stereo text display. In one scenario the button for receiving a call on cell phone XD4 may be translated by ABIFI 110 into a set mute request packet to stereo system OEM D1.

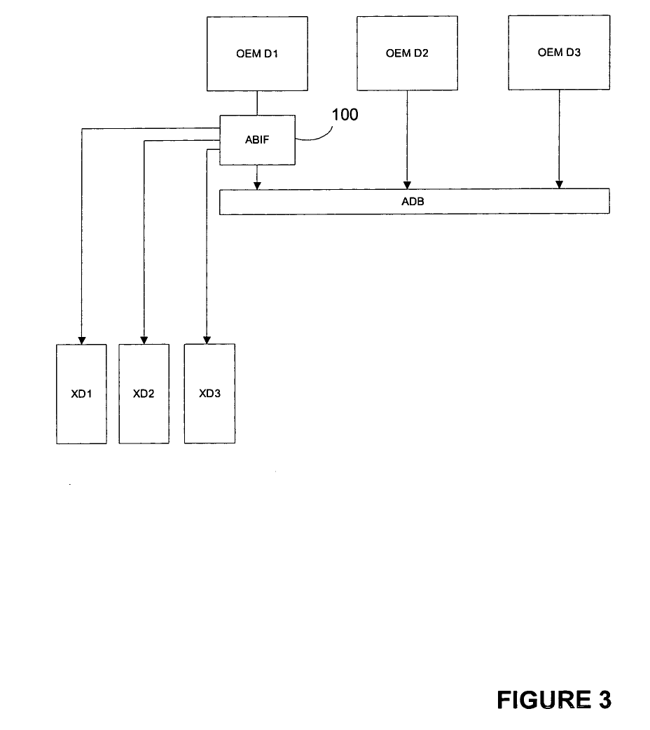

FIG. 3 shows an architectural diagram of a packet filter embodiment of the invention placed in between an existing device and an automotive data bus. Intercepting packets on automotive data bus ADB allows for the packets to be delayed while for example the text message on the stereo text display OEM D1 is maintained until incoming call to cell phone XD1 is answered at which time the originally intended packet is then delivered to the text display of the stereo text display. An example of an originally intended packet may be the title of a song that has started playing on automobile CD player OEM D3.

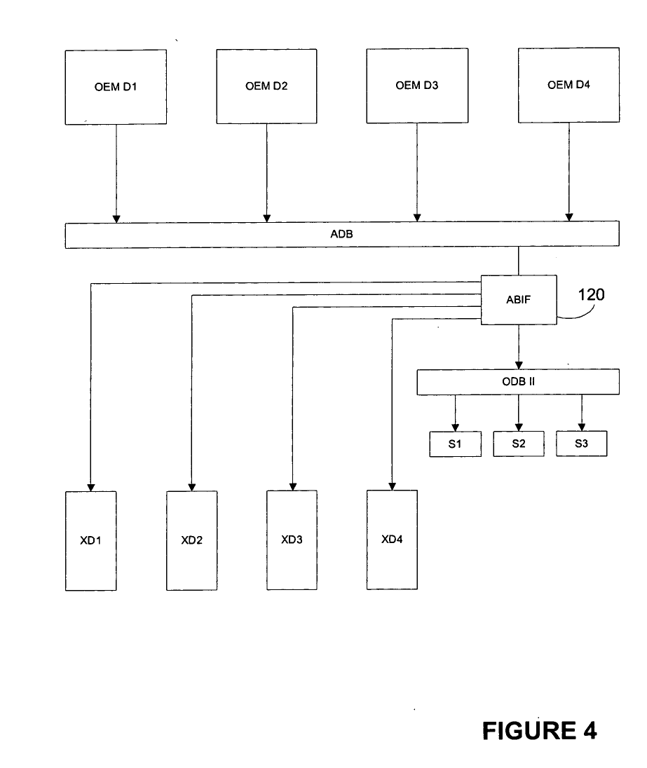

FIG. 4 shows an architectural diagram of an alternate bus packet translation embodiment of the invention coupling a second automotive bus such as the On Board Diagnostic II bus to an automotive data bus. When acting as a bridge between the automotive data bus and the on-board diagnostic bus in the automobile allows for example the oil pressure from oil pressure sensor S2 to be displayed on the main digital readout for the car or on stereo text display OEM D1 via ABIF 120 even if the original manufacturer did not intend for the end user to ever have access to the on board diagnostic information. Although the on-board diagnostic bus in the automobile exists, it is rarely available to the vehicle operator. Allowing the vehicle operator to access the on board diagnostic information saves the purchase of a car computer. In this topology, the oil pressure may be displayed on PDA XD2 or sent to any other external device coupled with ABIF 120.

Although the embodiments shown in FIGS. 1, 2, 3 and 4 comprise 4 OEM devices and 4 external devices, these cardinalities are exemplary only. Any number of OEM devices and external devices may be integrated.

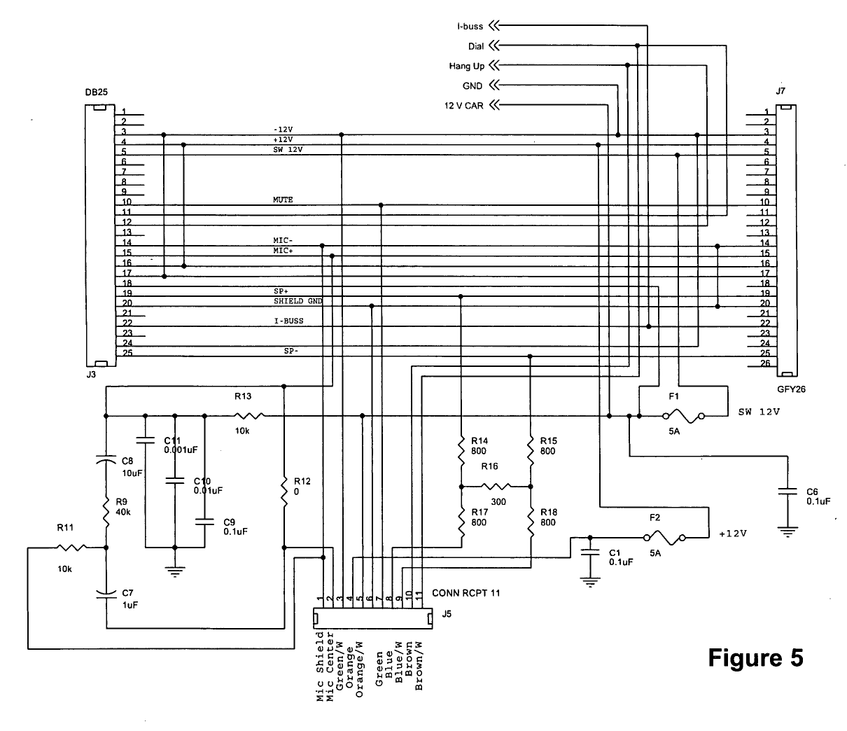

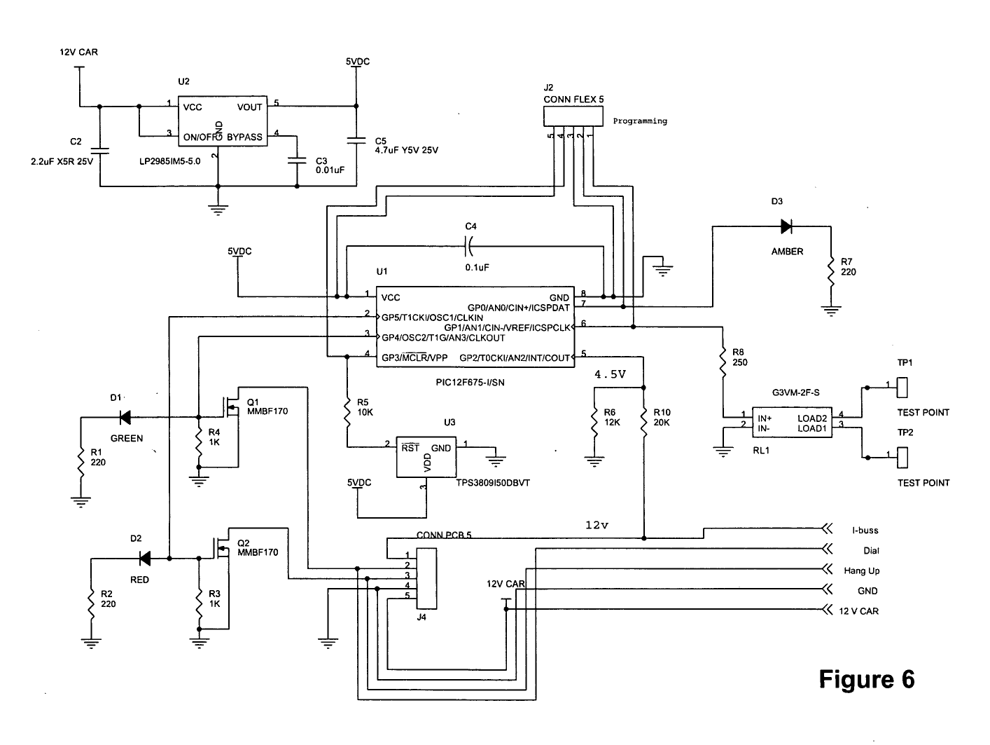

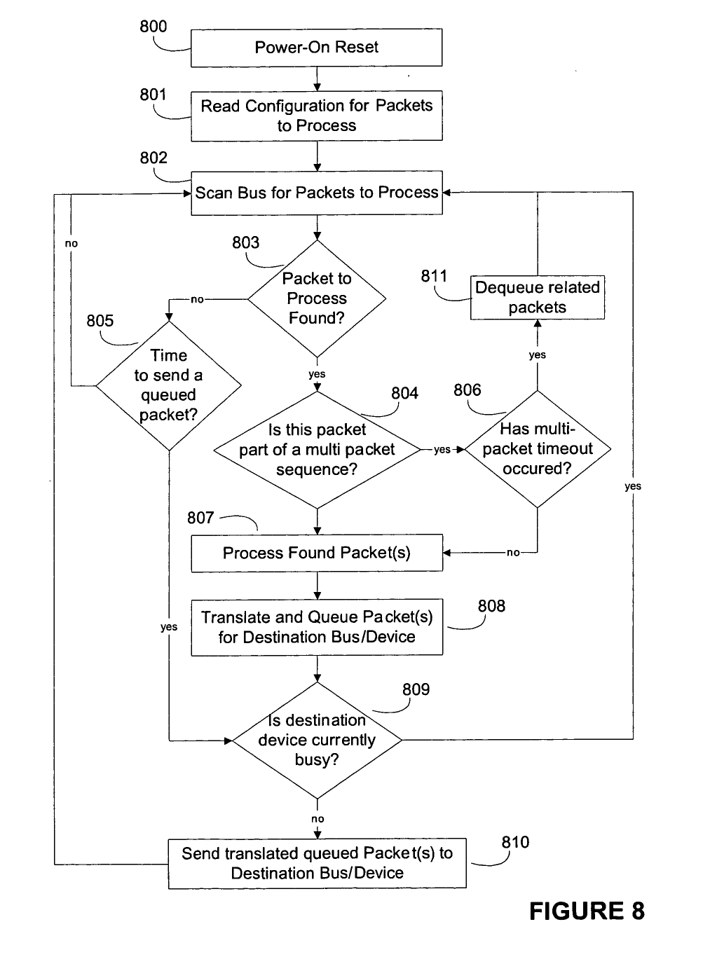

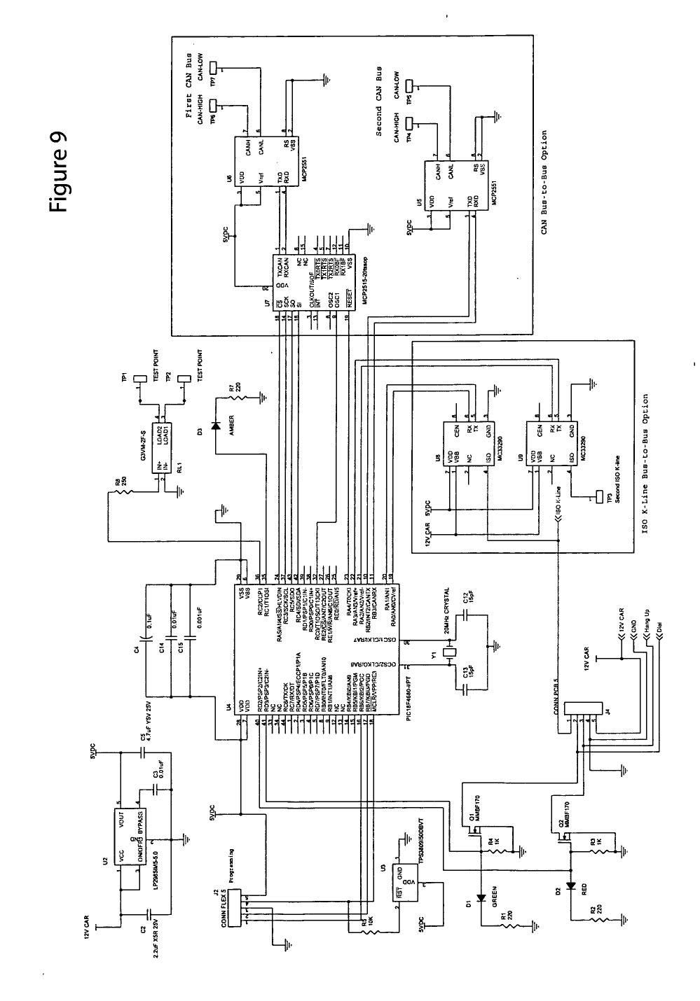

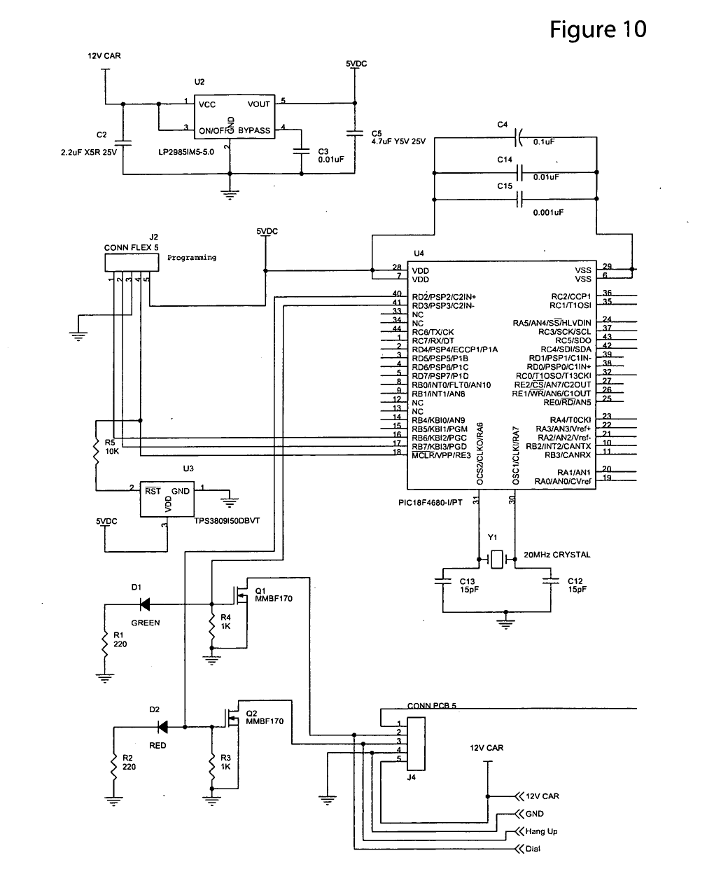

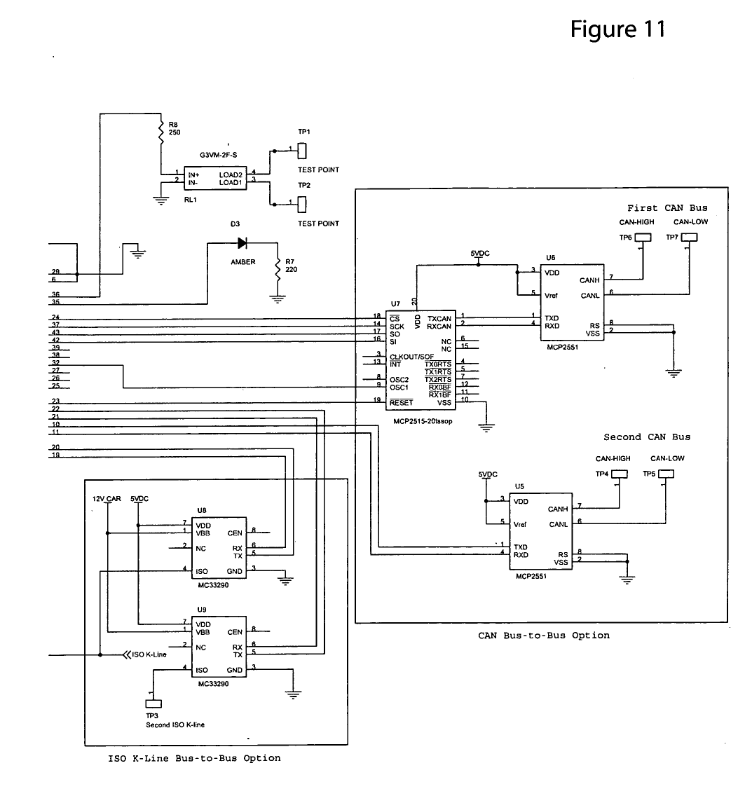

FIG. 5 shows a first schematic diagram of a portion of an embodiment of the invention comprising automotive data bus interface connector J7 (for a BMW 3 series automobile) and automotive data bus interface connector J3 (for BMW 5 series and most other makes and models), powered microphone interface comprising resistors R9, R11, R12, R13 and capacitors C7-C11, audio attenuator comprising resistors R14-R18 and cell phone interface connector J5. Also shown are fuses F1 and F2 and signals traveling to FIG. 6, namely signals 2, 3, 5, I-buss and Ground GND. Signal 22 of J3 and J7 is the I-buss signal which is the data signal of the automotive data bus. The I-buss signal is also known as the ISO K-Line signal (see FIGS. 9-11). This signal comprises all information sent in packets over the automotive data bus. FIG. 6 shows a second schematic diagram of a portion of an embodiment of the invention comprising microprocessor U1 which may be a 8 bit microprocessor, relay switch RL1 for use as a general relay in operating such devices as a garage door opener for example, voltage regulator U2 and programming interface connector J2. Power up reset device U3 resets microprocessor U1 on power-up. LEDs D1, D2 and D3 are used for displaying good and bad packet receipts for debugging purposes and are optional. Connector J4 is an optional connector for connecting to another ABIF and is not required. Signal I-buss from the automotive data bus connector J3 or J7 enters pin 5 of microprocessor U1 and is processed as per the algorithm in FIG. 8. For example if the driver of a car hears the cell phone ringing and depresses a steering wheel button once, the button press generates a packet on the I-buss that arrives at pin 5 of microprocessor U1 which is processed and in turn results in the assertion of signal “Dial” in order to allow the cell phone to be answered. Similarly, two button presses on the steering wheel may act as a “flash” signal to the cell phone to answer a second incoming call or switch between calls for example. Note that J5 may couple with and drive a general purpose Bluetooth interface that allows for a large number of local devices to couple with the automotive data bus via an ABIF without requiring hardwired connections. Alternatively, any number of existing hardware interfaces may be added and driven by microprocessor U1 such as a USB connector, a Fire-Wire connector or any other desired interface. One or more embodiments of the invention may drive an alternate bus interface chip via microprocessor U1, or alternatively drive a second bus. For example the signal labeled “Dial”, i.e., pin 3 of microprocessor U1 may drive a second bus and if microprocessor U1 is configured to communicate with a particular bus, such as the ODB-II bus.

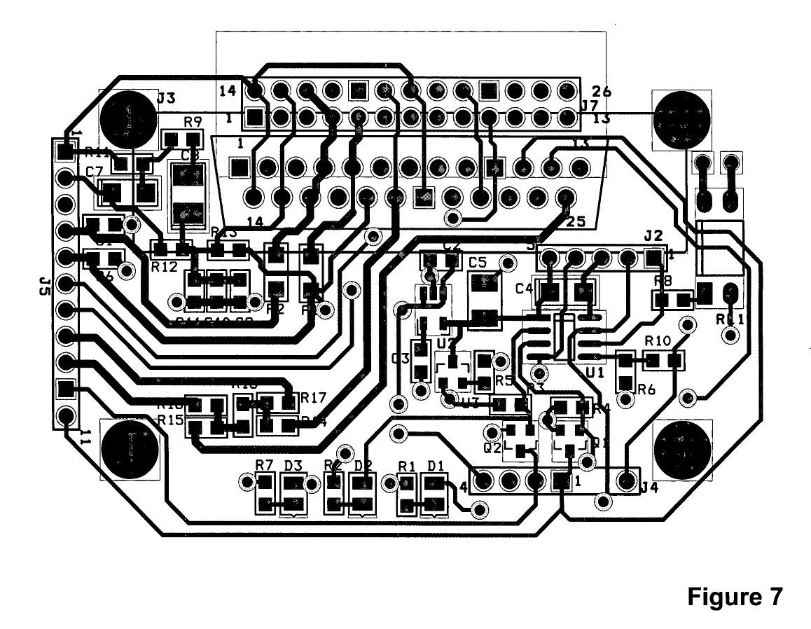

FIG. 7 shows a circuit board diagram of an embodiment of the invention as diagrammed in FIGS. 5 and 6. Of the two connector mounts at the top of the diagram, generally only the particular connector for the desired automobile is populated. For example for a BMW 3 series, J7 is populated, for most other cars the DB25 connector shown below J7 is populated with a connector. The other components are shown on FIGS. 5 and 6 including microprocessor U1 and cell phone/Bluetooth interface J5.

FIG. 9 FIG. 9 shows an embodiment of the invention configured to operate as a packet translator, packet filter and as a bus translator. Microprocessor U4 is a more powerful processor than microprocessor U1 in FIG. 6. Any microprocessor capable of packet translation, packet filtering or bus filtering may be substituted for microprocessor U4. The ISO K-Line signal of FIG. 9 is also known as the I-buss signal of FIG. 6. The term I-buss and the term ISO K-Line are synonymous and interchangeable. The portion of the circuit diagram labeled ISO K-Line Bus-to-Bus Option may comprise one or two bus interface chips. For example in a packet filter topology or packet translator topology, U8 may be configured into the circuit board while leaving the socket for U9 unpopulated on the circuit board. This is possible since pin 4 of U8 is bi-directional and is used by microprocessor U4 to read and write the physical layer of the automotive bus. Installing bus interface chip U9 allows for two separate automotive buses of the same type to be bridged in the bus translator topology. Similarly, the CAN Bus-to-Bus Option portion of the circuit diagram may comprise one bus interface chip U5, or may also comprise a second bus interface chip U6 along with CAN bus controller U7. Microprocessor U4 comprises a built-in CAN bus controller and therefore U5 does not require a corresponding CAN bus controller as U6 does. Since an automobile may or may not comprise more than one bus type, the corresponding ISO K-Line or CAN Bus-to-Bus options may be selectively populated. One or more embodiments of the invention may populate all chips allowing for one embodiment of the invention to be utilized for any bus type and any topology.

FIG. 8 shows a flow diagram of an embodiment of the software running on the microprocessor of FIG. 6 and FIG. 9. As shown in FIG. 6, power reset device U3 is coupled with microprocessor U1. At power on microprocessor U1 is reset at 800. The configuration of packets to process is loaded for processing at 801. Microprocessor U1 scans the I-buss signal for packets of interest to process at 802. If a packet is found that has been configured to be processed at 803, then the packet is checked to determine if the packet is part of a multi-packet sequence (for example a double click of a OEM button) at 804. If the packet found is not packet that is to be processed or optionally at a timeout interval then the queue of packets waiting for transmittal is check to determine if it is time to send a packet at 805. If it is not time to send a packet then the bus is scanned again at 802. Returning to step 804, if the packet is part of a multi-packet sequence then a timeout is checked at 806 to determine if the time gap between a plurality of packets has been reached. If the latest packet is received after the timeout has expired then the other queued packets that were part of the timeout check are dequeued at 811 and the bus is scanned for other packets of interest to process at 802. If the multi-packet timeout has not been reached then the packet(s) are processed at 807. This may entail converting multiple packets into a new logical command for example or converting units of a packet comprising sensor data. The packets are then translated for the desired bus or device at 808 and placed into packets that may be processed successfully by the destination device. If the destination device is being used by an ABIF currently or is busy for any other reason at 809, then the packet remains on the queue as per step 808, otherwise the packet is dequeued and sent to the destination bus or device at 810. The program continues forever at 802.

Thus embodiments of the invention directed to an apparatus and method for manipulating automotive data packets have been exemplified to one of ordinary skill in the art. The claims, however, and the full scope of any equivalents are what define the metes and bounds of the invention.

What is claimed is:

1. An apparatus for manipulating automotive data packets comprising:
a microprocessor;
at least one automotive data bus specific interface connector coupled with said microprocessor and coupled with at least one automotive data bus;
at least one external device specific interface coupled with said microprocessor and coupled with at least one external device; and,
said microprocessor configured to communicate with said at least one automotive data bus using at least one automotive data bus communications protocol and configured to communicate with said at least one external device using at least one external device communications protocol.

2. The apparatus of claim 1 wherein said at least one automotive data bus comprises K-bus.

3. The apparatus of claim 1 wherein said at least one automotive data bus comprises CAN Bus.

4. The apparatus of claim 1 wherein said at least one automotive data bus comprises OBD-II.

5. The apparatus of claim 1 wherein said at least one automotive data bus comprises SAEJ 1580.

6. The apparatus of claim 1 wherein said at least one external device specific interface comprises Bluetooth.

7. The apparatus of claim 1 wherein said at least one external device specific interface comprises USB.

8. The apparatus of claim 1 wherein said at least one external device specific interface comprises Firewire.

9. An apparatus for manipulating automotive data packets comprising:
a microprocessor;
a plurality of automotive data bus specific interface connectors coupled with said microprocessor and coupled with a plurality of automotive data buses; and
said microprocessor configured to communicate with a first automotive data bus selected from said plurality of automotive data buses using a first automotive data bus communications protocol and configured to communicate with a second automotive data bus selected from said plurality of automotive data buses using a second automotive data bus communications protocol.

10. A method for manipulating automotive data packets comprising:
coupling at least one automotive data bus specific interface connector with a microprocessor and with at least one automotive data bus;
coupling at least one external device specific interface with said microprocessor and with at least one external device; and,
communicating via said microprocessor with said at least one automotive data bus using at least one automotive data bus communications protocol; and,
communicating via said microprocessor with said at least one external device using at least one external device communications protocol.

11. The method of claim 11 further comprising:
reading a packet from said at least one automotive data bus.

12. The method of claim 11 further comprising:
writing a packet to said at least one automotive data bus.

13. The method of claim 11 further comprising:
reading a packet from said at least one external device specific interface.

14. The method of claim 11 further comprising:
writing a packet to said at least one external device specific interface.

15. The method of claim 11 further comprising:
reading a packet from a first external interface selected from said at least one external device specific interface; and,
writing a converted packet to a first bus selected from said at least one automotive data bus.

16. The method of claim 11 further comprising:
reading a packet from a first bus selected from said at least one automotive data bus; and,
writing a converted packet to a first external interface selected from said at least one external device specific interface.

17. The method of claim 11 further comprising:
reading a packet from a first external interface selected from said at least one external device specific interface; and,
writing a converted packet to a second external interface selected from said at least one external device specific interface.

18. The method of claim 11 further comprising:
reading a packet from a first external device; and,
writing a converted packet to a second external device.

19. The method of claim 11 further comprising:
reading a packet from a first bus selected from said at least one automotive data bus; and,
writing a converted packet to a second bus selected from said at least one automotive data bus.

20. An apparatus for manipulating automotive data packets comprising:
means for coupling at least one automotive data bus specific interface connector with a microprocessor and with at least one automotive data bus;
means for coupling at least one external device specific interface with said microprocessor and with at least one external device; and,
means for communicating via said microprocessor with said at least one automotive data bus using at least one automotive data bus communications protocol; and,
means for communicating via said microprocessor with said at least one external device using at least one external device communications protocol.
